(19) United States
(12) Patent Application Publication
(10) Pub. No.: US 2012/0105254 A1
(43) Pub. Date: May 3, 2012

(54) Warning light for atmospheric electrical generator

(76) Inventor: Mark Ellery Ogram, Tucson, AZ (US)

(21) Appl. No.: 12/925,826

(22) Filed: Oct. 30, 2010

(51) Int. Cl. G08B 21/00; G09F 9/33

(52) U.S. Cl. 340/946; 340/815.4; 340/815.45

(57) ABSTRACT

A warning light for use with a lighter than air balloon comprises a central core with one or more light sources coupled to the central core. Rotors are rotatably coupled to the central core with each of the rotors having a mirrored surface and a non-mirror surface. When the rotors rotate about the central core under a wind force, the mirrored surface of each of said rotors reflecting light emitted from said light sources.

### TECHNICAL FIELD OF THE INVENTION

The present invention relates to the production of electrical energy and more specifically to a warning light for atmospheric electrical generators.

### BACKGROUND OF THE INVENTION

In 1752, Benjamin Franklin performed his famous kite experiment using a kite attached to a wet kite string. Negative charges of electricity from the passing clouds flowed into the string down to a suspended metal key and collected in a Leyden Jar via a thin metal wire attached to the key. As Mr. Franklin was holding a dry silk string, he was not injured by the electricity.

Since that time, the possibility of collecting electricity has intrigued many. Lightening itself holds a vast amount of power. The power is so immense that it has proven impossible to collect. However, lightening is only a final discharge of static electricity in the atmosphere. Collecting the static electricity in the air would provide an alternative energy source. One way to collect the static electricity is via a balloon coupled to a conductive tether. The charge collected by the balloon can then be transmitted along the conductive tether and collected. Such an atmospheric electrical generator is disclosed in patent application Ser. No. 12/218,297 filed on Jul. 14, 2008 by Mark Ogram and entitled “Atmospheric Electrical Generator”. This patent is hereby incorporated by reference.

However, it is important to provide a warning light for the balloon. This allows the balloon to be spotted by aircraft pilots and others to avoid accidents. However, it is also important to minimize the weight of any illumination source. Therefore, there is a continuing need for an illumination source that is self contained and light-weight.

### BRIEF SUMMARY OF THE INVENTION

In one embodiment of the present invention a warning light for use with a lighter than air balloon comprises a central core with one or more light sources coupled to the central core. Rotors are rotatably coupled to the central core with each of the rotors having a mirrored surface and a non-mirror surface. When the rotors rotate about the central core under a wind force, the mirrored surface of each of said rotors reflecting light emitted from said light sources.

In another embodiment of the present invention, an atmospheric electrical generator comprises a lighter than aircraft having a conductive tether with a first end electrically coupled to the aircraft. A warning light is coupled to the tether.

In this embodiment, the warning light comprises a central core with one or more light sources coupled to the central core. Rotors are rotatably coupled to the central core with each of the rotors having a mirrored surface and a non-mirror surface. When the rotors rotate about the central core under a wind force, the mirrored surface of each of said rotors reflecting light emitted from said light sources.

### BRIEF DESCRIPTION OF THE DRAWINGS

The present invention will hereinafter be described in conjunction with the following drawing figures, wherein like numerals denote like elements, and:

FIG. 1 diagrams a system for collecting energy with a warning light;

FIG. 2 diagrams the warning lights for the balloon; and

FIG. 3 diagrams a rotation device of the warning light.

### DETAILED DESCRIPTION OF THE PREFERRED EMBODIMENTS

The following detailed description of the invention is merely exemplary in nature and is not intended to limit the invention or the application and uses of the invention. Furthermore, there is no intention to be bound by any theory presented in the preceding background of the invention or the following detailed description of the invention.

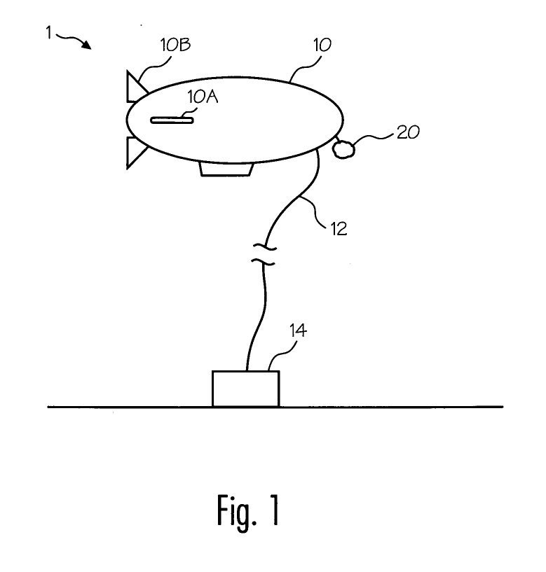

In an exemplary embodiment of the present invention, FIG. 1 diagrams the preferred embodiment of the invention.

Balloon 10 is an aircraft which, in this illustrating, is a lighter than air balloon. Wings 10A, extending from the body of balloon 10, provide additional lift in air flow 18. Tail 10B helps to stabilize balloon 10.

Balloon 10 is tethered to the ground via conductive line 12. As noted earlier, a variety of configurations and materials are available to serve as conductive line 12. In this illustration, a poly-wire is used. Poly-wire is commercially available through a variety of vendors, including, but not limited to: Jefferson Livestock and Sareba Systems, Inc. of Ellendale, Minn. The electricity flows down the conductive line 12 where it is collected at station 14.

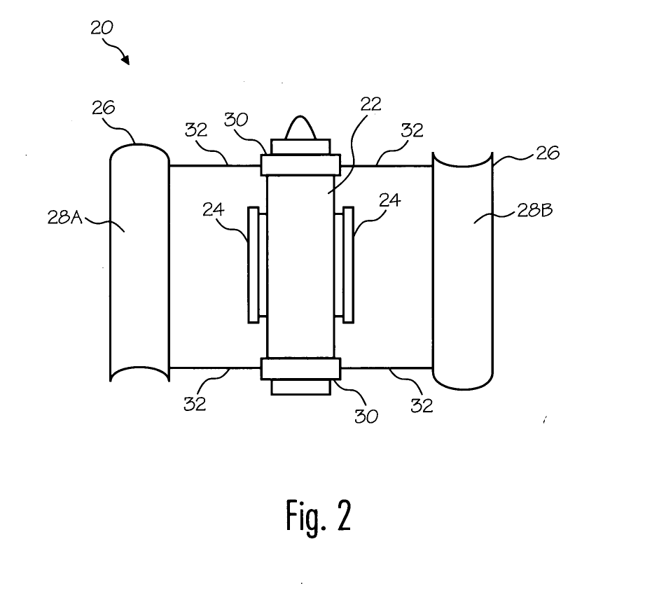

FIG. 2 diagrams the preferred embodiment of warning light 20. In an exemplary embodiment the warning light 20 is coupled to the conductive line 12 of the balloon 10. However, warning light 20 can be attached to the balloon, to a non-conductive line attached to the balloon 10.

As illustrated in FIG. 2, warning light 20 comprises a central core 22 including one or more rotating devices 30. One or more light sources 24 are coupled to the central core 22. Rotors 26 are rotatably coupled to the rotation devices 30 via arms 32 such that they rotate about the central core 22.

Light sources 24, in an exemplary embodiment, are light weight sources of illumination that are designed to illuminate for a period of time without the need for replenishing the power supply. In a preferred embodiment, light sources 24 are a chemiluminescent device which provides light through a chemical reaction without the need for an electrical power source. Chemiluminescent devices are commonly known as “glow sticks”. Suitable “glow sticks” are described in U.S. Pat. No. 3,893,118 entitled “Chemiluminescent Signal Device” issued to Esposito et al. in January 1976, which is hereinafter incorporated by reference. In alternate embodiments, light sources 24 can be LED lights, which can be powered by batteries, a generator coupled to the rotating devices 30 and the like.

Rotors 26, in a preferred embodiment, have a first concave mirrored surface 28a and a second non-mirrored side 28b. In one preferred embodiment, at least two rotors 26 are deployed as a pair, opposite each other such that one rotor displays its mirrored surface 28a and the other rotor displays its non-mirrored side 28b.

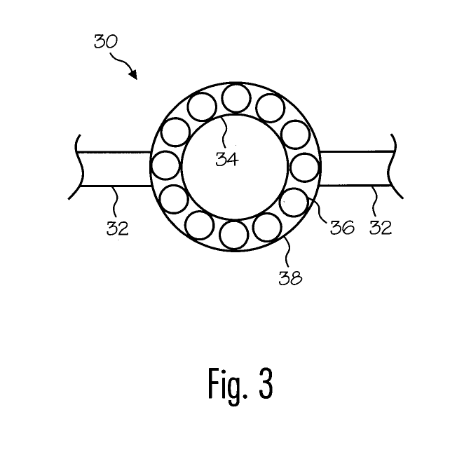

Rotating device 30 couples to the central core 22 and the rotors 26 to allow the rotors 26 to rotate about the central core 22. As shown in FIG. 3, rotating device 30 comprises an inner annulus 34 and an outer annulus 38 with a plurality of ball bearing 36 between the inner annulus 34 and the outer annulus 38. In a preferred embodiment inner annulus 34 is mounted to central core 22. This allows the outer annulus 38 to rotate about the fixed inner annulus 34.

While two rotating devices 30 are shown in FIG. 2, more or fewer rotating devices 30 can be placed on central core 40 depending on design preference.

As seen in FIG. 2, arms 32 couple the rotors 32 to the rotating device 30.

In operation, warning light 20 is coupled to tether 12 near balloon 10. The glow sticks are activated to produce illumination. The balloon 10 is then deployed. When the balloon 10 is deployed and at altitude, wind will cause the rotors 26 to rotate around the central core 22. The mirrored surface 28a reflects light out from the light sources 24. To an observer away from the balloon 10, the light observed will be a blinking light as the light sources 24 will be alternately reflected and blocked by the rotors 26.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A warning light for use with an aircraft comprising:
a central core;
one or more light sources coupled to said central core;
one or more rotors rotatably coupled to said central core, each of said rotors having a mirrored side and a non-mirror side, and;
wherein said rotors rotate about said central core under a wind force, the mirrored side of each of said rotors reflecting light emitted from said light sources.

2. The warning light of claim 1 wherein said light sources are glow sticks.

3. The warning light of claim 1 further comprising rotating devices mounted to said central core and coupled to said rotors.

4. The warning light of claim 3 wherein said rotating devices further comprises a fixed inner annulus coupled to said central core, an outer annulus coupled to said rotors and a plurality of ball bearings disposed between the inner annulus and the outer annulus.

5. The warning light of claim 3 wherein said aircraft is a lighter than air balloon.

6. The warning light of claim 1 wherein said light sources are LED lights.

7. An atmospheric electrical generator comprising:
a lighter than air aircraft;
a conductive tether comprising a first end electrically coupled to said aircraft; and,
a warning light coupled to said tether.

8. The atmospheric electrical generator of claim 7 where in the warning light comprises:
a central core;
one or more light sources coupled to said central core;
one or more rotors rotatably coupled to said central core, each of said rotors having a mirrored side and a non-mirror side, and;
wherein said rotors rotate about said central core under a wind force, the mirrored side of each of said rotors reflecting light emitted from said light sources.

9. The atmospheric electrical generator of claim 7 wherein said light sources are glow sticks.

10. The atmospheric electrical generator of claim 7 further comprising rotating devices mounted to said central core and coupled to said rotor.

11. The atmospheric electrical generator of claim 10 wherein said rotating devices further comprises a fixed inner annulus coupled to the central core, an outer annulus coupled to the rotors and a plurality of ball bearings disposed between said inner annulus and said outer annulus.

12. The atmospheric electrical generator of claim 7 wherein said warning light is coupled to a lighter than air balloon.

13. The atmospheric electrical generator of claim 7 wherein said light sources are LED lights.

14. A warning light comprising:
a central core;
a light source coupled to said central core,
a rotational device mounted to said central core;
a rotor rotatable coupled to said rotating device, said rotor having a mirrored side operable to reflect light generated by the light source.

15. The warning light of claim 14 wherein said light sources are glow sticks.

16. The warning light of claim 14 wherein said rotating devices further comprise a fixed inner annulus coupled to said central core, an outer annulus coupled to said rotors and a plurality of ball bearings disposed between said inner annulus and said outer annulus.

17. The warning light of claim 14 wherein said warning light is coupled to a lighter than air balloon.

18. The warning light of claim 14 wherein said light source are LED lights.
